(19) United States
(12) Patent Application Publication
(10) Pub. No.: US 2016/0180354 A1
(43) Pub. Date: Jun. 23, 2016

(54) RESOURCE PROPAGATION METHOD AND SYSTEM

(71) Applicant: Shenzhen Development Promotion Centre for Enterprises, Shenzhen (CN)

(72) Inventor: JIMMY CHUN, Shenzhen (CN)

(73) Assignee: Shenzhen Development Promotion Centre for Enterprises, Shenzhen (CN)

(21) Appl. No.: 14/590,167

(22) Filed: Jan. 6, 2015

(30) Foreign Application Priority Data
Dec. 22, 2014 (CN) 201410810590.4

(51) Int. Cl. G06Q 30/02

(52) U.S. Cl. CPC G06Q 30/0201

(57) ABSTRACT

The present invention is applicable to the computer field, and provides a resource propagation method and system. The method includes the following steps: assembling acquired content into structured data; generating a resource address for the structured data, where the resource address includes a propagation path parameter, in a process of propagating the resource address, updating the propagation path parameter according to propagator information of the resource address; and tracing a propagation path of the resource address according to an updated propagation path parameter, where the propagation path parameter is used to identify a propagation behavior between a propagator and a previous propagator of the resource address. According to the present invention, contributions made by different propagation phases to resource propagation can be evaluated and counted, so as to stimulate different phases to expand resource propagation, thereby greatly increasing value generated due to resource propagation.

### TECHNICAL FIELD

The present invention pertains to the computer field, and in particular, to a resource propagation method and system.

### BACKGROUND

With rapid development of the Internet, an increasing number of resources such as texts, pictures, audio, and videos are propagated on the Internet, and the Internet becomes an important channel through which users search for, find, acquire, and propagate resources. Furthermore, after finding and acquiring resources, the users can propagate the resources on the Internet by means of sharing, forwarding, and the like.

As resources are propagated on the Internet, various operation modes such as advertisement push, VIP membership, content payment, and value-added service are generated. All of these operation modes need to be supported by effective statistics about propagation situations of resources.

Currently, in a process of propagating resources on the Internet, only some propagation phases such as a current propagator and a previous propagator can be counted and traced, and different propagation phases of resources in an entire propagation process cannot be effectively traced, thereby making it difficult to evaluate contributions made by different propagation phases to resource propagation.

### SUMMARY

Embodiments of the present invention provide a resource propagation method, aiming to resolve a problem that currently, it is difficult to effectively trace different propagation phases of a resource in an entire propagation process on the Internet, and it is difficult to evaluate contributions made by different propagation phases to resource propagation.

The embodiments of the present invention are implemented in such a way that a resource propagation method is provided, where the method includes the following steps:

assembling acquired content into structured data;

generating a resource address for the structured data, where the resource address includes a propagation path parameter;

in a process of propagating the resource address, updating the propagation path parameter according to propagator information of the resource address; and

tracing a propagation path of the resource address according to an updated propagation path parameter, where

the propagation path parameter is used to identify a propagation behavior between a propagator and a previous propagator of the resource address.

An embodiment of the present invention further provides a resource propagation system, where the system includes:

a structured data assembling component, configured to assemble acquired content into structured data;

a resource address generating component, configured to generate a resource address for the structured data, where the resource address includes a propagation path parameter,

a resource address updating component, configured to: in a process of propagating the resource address, update the propagation path parameter according to propagator information of the resource address; and

a propagation path tracing component, configured to trace a propagation path of the resource address according to an updated propagation path parameter; where

the propagation path parameter is used to identify a propagation behavior between a propagator and a previous propagator of the resource address.

According to the embodiments of the present invention, to-be-propagated content is assembled into structured data, a resource address that includes a propagation path parameter is generated for the structured data, and different propagation phases of a resource are traced by using the propagation path parameter in the resource address. Therefore, contributions made by different propagation phases to resource propagation can be evaluated and counted, so as to stimulate different phases to expand resource propagation, thereby greatly increasing value generated due to resource propagation.

### BRIEF DESCRIPTION OF DRAWINGS

FIG. 1 is a schematic diagram of an implementation environment of a resource propagation method according to an embodiment of the present invention;

FIG. 2 is an implementation flowchart of a resource propagation method according to an embodiment of the present invention;

FIG. 3 is an implementation flowchart of updating a propagation path parameter according to an embodiment of the present invention;

FIG. 4 is an exemplary diagram of a resource propagation process according to an embodiment of the present invention;

FIG. 5 is a structural diagram of a resource propagation system according to an embodiment of the present invention;

FIG. 6 is a structural diagram of a propagation path parameter updating component according to an embodiment of the present invention;

FIG. 7 is a structural diagram of a propagation path tracing component according to an embodiment of the present invention; and

FIG. 8 is a schematic structural diagram of a server according to an embodiment of the present invention.

### DESCRIPTION OF EMBODIMENTS

To make the objectives, technical solutions, and advantages of the present invention clearer and more comprehensible, the following further describes the present invention in detail with reference to the accompanying drawings and embodiments. It should be understood that the specific embodiments described herein are merely used to explain the present invention but are not intended to limit the present invention.

According to embodiments of the present invention, to-be-propagated content is assembled into structured data, a resource address that includes a propagation path parameter is generated for the structured data, and different propagation phases of a resource are effectively traced by using a propagation path parameter in the resource address.

In the embodiments of the present invention, the resource may be content such as a text, a picture, audio, or a video, and can be propagated on the Internet by means of forwarding, sharing, and the like behavior.

FIG. 1 shows an implementation environment of a resource propagation method according to an embodiment of the present invention, where the implementation environment includes multiple clients 121 that run on a terminal device 120, one or more content servers 140, and one or more resource propagation servers 160.

The client 121 runs on the terminal device 120 of a user, may be provided by a content service provider such as a browser client, a forum client, a mailbox client, a microblog client, an entertainment client, a network audio player client, or a network video player client, and may also be a dedicated resource propagation client.

The terminal device 120 may be a personal computer, a smart television set, a smartphone, a tablet computer, an ebook reader, a moving Picture Experts Group Audio Layer III (MP3) player and a moving Picture Experts Group Audio Layer IV (MP4) player, a TV set, a laptop computer, a desktop computer, or the like.

The content server 140 stores content of resources that are propagated on a network, and the content may include a text, audio, a video, a picture, and the like.

The resource propagation server 160 may communicate with the client 121 through a wireless network or a wired network. The user acquires a resource address of content from the resource propagation server 160 by using the client 121, acquires corresponding content from the content server 140 by using the resource address, browses, downloads, or plays the content, and may share the content with another user or forward the content to another user.

In this embodiment of the present invention, a resource propagation server 160 assembles acquired content into structured data, generates a resource address for the structured data, where a propagation path parameter is configured in the resource address; in a process of propagating the resource address, updates the propagation path parameter according to propagator information, and traces a propagation path of the resource address according to an updated propagation path parameter.

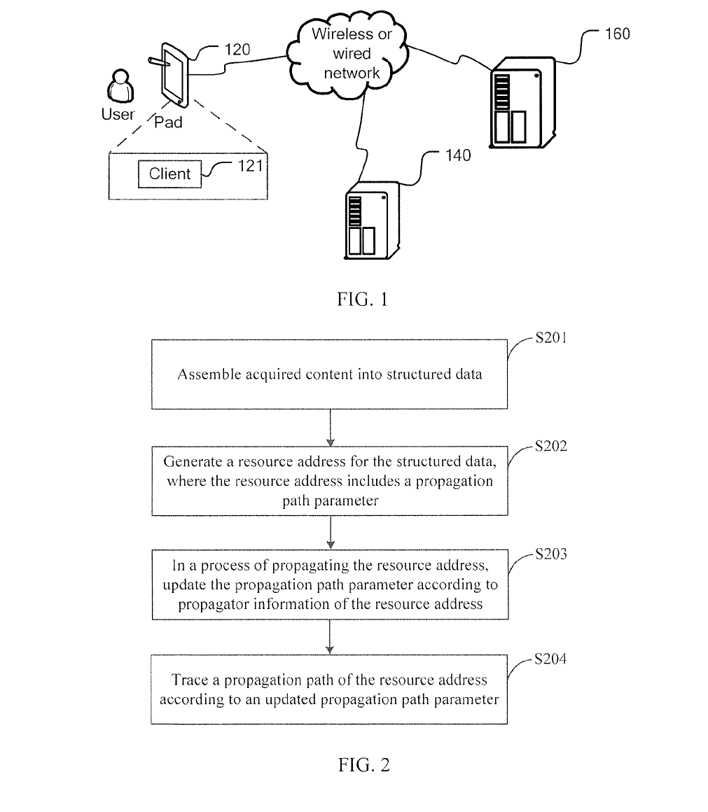

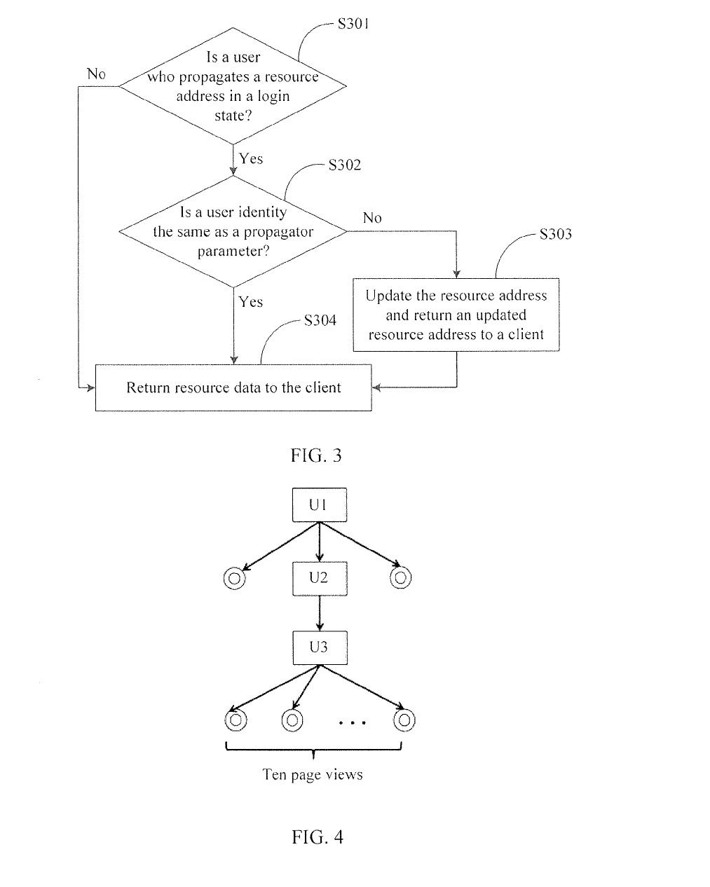

FIG. 2 shows an implementation procedure of a resource propagation method according to an embodiment of the present invention. Details are described as follows:

In step S201, acquired content is assembled into structured data.

In this embodiment of the present invention, the content may be acquired by using a resource address that points to the content, and may also be acquired in a manner of downloading or receiving an uploaded file, or the like.

In this embodiment of the present invention, after the content is acquired, the content is assembled into the structured data. A purpose of assembling the content into the structured data is to help flexibly add, modify, or delete other data or information after structured processing is performed on the content.

In an embodiment of the present invention, to enable content propagation to generate business value, enable a producer and a propagator of the content to obtain revenue, and facilitate content propagation, the structured data includes content value-added information.

In an embodiment of the present invention, the content value-added information may be payment prompt information of the content. For example, when the content is an article, the payment prompt information may be information about charging by word count or prompt information of charging by month; when the content is a movie, the payment prompt information may be information about charging by movie or prompt information of charging by month.

In another embodiment of the present invention, the content value-added information may be advertisement content data. In this case, when browsing the content, a user can view an advertisement added to the content, and the advertisement may be dynamically configured or adjusted.

In an embodiment of the present invention, the structured data may be stored in a file or database form.

In an example in which the structured data is stored in the file form, a structured data ID may be used as a file name, and the structured data is stored in an XML format.

For example, a stored file 123456.xml whose structured data ID is 123456 may be expressed as follows:

<strdata id=“123456”><content type=“video”>
http://example.com/video/abc
</content></strdata>.

In an example in which the structured data is stored in the database form, a structured data table may be created in a relational database. For example,

a table field is (id, type, content, ad), and a row of data (123456, “movie”, content data packet, blank) is written. The structured data table refers to a table created in a database, and is used to store a structured data packet. In the table field, id is a structured data ID, type is a content type, content is a content data packet, and ad is a content value-added information field. The content value-added information field may include a resource address and a presentation parameter of content value-added information. When initial content is imported, the content value-added information field is a blank character string.

In step S202, a resource address is generated for the structured data, where the resource address includes a propagation path parameter.

In this embodiment of the present invention, the resource address points to a storage location of the structured data, and the user can acquire and view the structured data by accessing the resource address.

If the structured data is propagated on the Internet, the resource address usually uses a uniform resource locator (Uniform Resource Locator, URL).

The URL is a simple expression of a location and an access method of a resource that can be obtained from the Internet, and is a standard resource address of the resource on the Internet. Each resource on the Internet has a unique resource address, and information included in the resource address points out a location of the resource and points out that how a related application program such as a browser should process the resource address. The URL has been specified by the World Wide Web Consortium as the Internet standard RFC 1738.

If the structured data is propagated by using a client, the resource address may use a uniform resource identifier (Uniform Resource Identifier, URL).

For example, for an Android platform, the URL is mainly divided into three parts: a scheme, an authority, and a path, the authority is further divided into a host and a port, and a format is scheme://host:port/path.

In this embodiment of the present invention, the propagation path parameter is used to identify a propagation behavior between a propagator and a previous propagator of the resource address.

In a preferred embodiment of the present invention, the propagation path parameter includes the following information: a propagator parameter, a previous-propagator parameter, and a propagation behavior identity.

The propagator parameter is used to identify a user who performs login and propagates a current resource address, indicating who propagates the resource address. The propagator parameter is usually formed by a user identity used by the user to perform login. If a resource is original content, a propagator refers to a content producer.

The previous-propagator parameter is used to identify a previous propagator of the current resource address, indicating whom the resource address propagated by the propagator comes from. A purpose of carrying this parameter in the resource address is to enable a server side to trace a propagation path of the resource address, helping understand a propagation situation of the resource address.

The propagation behavior identity is used to identify a resource address propagation behavior between a propagator and a previous propagator. A backtracing analysis on the propagation path may be performed by using this parameter in combination with the previous-propagator parameter.

For example. A separately propagates a same resource address that is propagated by B and C, and then D propagates the resource address propagated by A. If there is no propagation behavior identity, the server side cannot backtrace an accurate propagation path of the resource address because for the propagation path, two situations exist: B→A→D and C→A→D.

In this embodiment of the present invention, the propagator parameter, the previous-propagator parameter, and the propagation behavior identity that are included in the propagation path parameter may be implemented in multiple manners. For example,

1. Three pieces of information, that is, the propagator parameter, the previous-propagator parameter, and the propagation behavior identity are configured in the resource address. An implementation example is as follows:

{sharer, prevSharer, shareNO}<-a propagator, a previous propagator, and a propagation behavior identity

2. The three pieces of information, that is, the propagator parameter, the previous-propagator parameter, and the propagation behavior identity are combined into one parameter in the resource address. An implementation example is as follows:

path=sharer|prevSharer|shareNO<-parameters are combined into a single propagation path parameter

3. The propagator parameter, the previous-propagator parameter, and the propagation behavior identity are combined into two parameters in the resource address. An implementation example is as follows:

node=sharer|shareNO&prevNode=prevSharer|prevShareNO<-a propagation path node and a previous propagation path node

4. The propagator parameter, the previous-propagator parameter, or the propagation behavior identity is stored in a database, and mapping is established in the resource address between a corresponding identity and the propagator parameter, the previous-propagator parameter, or the propagation behavior identity in the database.

In a preferred embodiment of the present invention, the propagation behavior identity is a base64 value that is obtained by converting a microsecond value of a UNIX time stamp. A conversion method is to find 64 characters to respectively represent 0 to 63, and a preferred solution for the 64 characters is to select 0 to 9, a to z, A to Z, −, and _.

In a preferred embodiment of the present invention, to help the server side quickly count a propagation depth of the resource address, the number of propagation layers is further configured in the propagation path parameter. Each time the resource address is propagated, the number of propagation layers is increased by 1, that is, the number of propagation layers of a resource address after propagation is the number of propagation layers of the original resource address plus 1. If the resource is propagator-originated, this parameter value is 0.

In a preferred embodiment of the present invention, to protect the resource address from unauthorized alteration and assembling, a parameter signature value is further configured in the resource address.

The parameter signature value is obtained by performing computation on the propagation path parameter in the resource address by using a signature algorithm. When any parameter in the propagation path parameter changes, the parameter signature value changes; therefore, it can be determined, by detecting whether the signature value changes, whether the resource address is altered or assembled without authorization.

In this embodiment of the present invention, it is defined that only a server side on which the resource address is located can generate a parameter signature value, and only a resource server can generate a new resource address.

A URL address based on the RFC 1738 standard is used as an example, and in the present invention, an implementation example of a resource address is as follows:

http://example.com/rs_123.html?sharer=UID_s&prevSharer=UID_p&shar eNO=aBCd12WxY&forwardLayer=1&sig=0123456789abcdef

where, the section preceding “?” is a resource prefix.

http indicates a transfer protocol, example.com indicates an address of a server side, leaving the network port number blank indicates a default value 80, and /rs_123.html indicates a path of a resource on the server side.

The section following “?” is a propagation path parameter and a parameter signature value, and detailed data is described as follows:

A propagator parameter “sharer=UID_s” indicates who propagates the resource address, and is usually formed by a user identity. If the resource is original content, a propagator in the resource address refers to a content producer.

A previous-propagator parameter “prevSharer=UID_p” indicates that the propagator of the resource address propagates the resource address that is propagated by a user UID_p. A purpose of carrying this parameter is to enable the server side to trace a propagation path of the resource address, helping understand a propagation situation of content. If the resource is propagator-originated, this parameter value is a blank character string.

A propagation behavior identity “shareNO=aBCd12WxY” is used to perform a backtracing analysis on the propagation path in combination with the previous-propagator parameter.

The number of propagation layers “forwardLayer=1” is used to help the server side quickly count a propagation depth of the resource address.

If the resource is propagator-originated, this parameter value is 0. Each time the resource address is propagated, this parameter value is increased by 1, that is, the number of propagation layers of a resource address after propagation is the number of propagation layers of the original resource address plus 1.

A parameter signature value “sig=0123456789abcdef” is used to protect the resource address from unauthorized alteration and assembling.

In step S203, in a process of propagating the resource address, the propagation path parameter is updated according to propagator information of the resource address.

In this embodiment of the present invention, in a resource propagation process, the propagation path parameter in the resource address is updated according to a login state and a user identity of a user who propagates the resource address.

FIG. 3 shows an implementation procedure of updating a propagation path parameter according to an embodiment of the present invention. Details are described as follows:

In step S301, when a user propagates a resource address, it is detected whether the user is in a login state, if the user is in the login state, step S302 is performed; if the user is not in the login state, step S304 is performed.

In an embodiment of the present invention, when a client propagates the resource address, a server side may detect, by using a cookie function, whether the user is in the login state.

After the user performs login, the server side generates a session ID and sends the session ID to the client. The client saves the session ID in a cookie by using sessionKey as a field name. Therefore, the server side only needs to check whether the cookie in a request sent by the browser client includes the sessionKey. If the cookie in a request sent by a client browser does not include the sessionKey, it can be determined that the user is in a non-login state; if the cookie in a request sent by a client browser includes the sessionKey, a user identity can be found by using the sessionKey.

In step S302, the user identity used by the user to perform login is compared with a propagator parameter in the resource address; it is determined whether the user identity used by the user to perform login is the same as the propagator parameter in the resource address, and if the user identity used by the user to perform login is the same as the propagator parameter in the resource address, step S304 is performed; the user identity used by the user to perform login is not the same as the propagator parameter in the resource address, step S303 is performed.

In step S303, the propagator parameter in the resource address is updated with the user identity used by the user to perform login; a previous-propagator parameter in the resource address is set to the propagator parameter before updating; and a propagation behavior identity is calculated and updated.

In an embodiment of the present invention, when a propagation path parameter includes the number of propagation layers, and each time the resource address is propagated, the number of propagation layers in the resource address is increased by 1.

In an embodiment of the present invention, when the resource address includes a parameter signature value, a parameter signature value is recalculated according to an updated propagation path parameter.

After the resource address is updated, an HTTP redirection header is formed by an updated resource address, and then returned to the client. The client responds to an HTTP redirection request, and returns to step S301.

In this embodiment of the present invention, if the login user propagates the resource address, the propagator parameter in the propagated resource address is the user identity for login.

In step S304, resource data is returned to the client, and the client presents a resource to the user.

In this embodiment of the present invention, the user may perform a user login action before resource propagation, and after successful login, refreshes a page and returns to step S301.

The user may also propagate content in the non-login state. In this case, the propagated resource address is the same as the original resource address, that is, the propagator parameter remains unchanged.

In step S204, a propagation path of the resource address is traced according to the updated propagation path parameter.

In this embodiment of the present invention, when there is a need to trace the propagation path of the resource address, the propagation path of the resource address may be acquired according to the updated propagation path parameter. For example, in the case of a large data volume, the server side may trace a resource propagation path of a resource such as an article or a video every one hour according to recorded user identity information and propagation behavior identity information.

In an embodiment of the present invention, the propagation path parameter is recorded in a form of a log.

For example, when user A propagates a resource, the resource is propagated after identity information and propagation behavior identity information of user A are added to an original resource address, for example, a resource addresshttp://bao.com/rs_123?sharer=UserA&shareNO=aBcD1, where UserA is a user identity of user A, and aBcD1 is a propagation behavior identity. The server side writes UserA and aBcD1 into a log (123, UserA, aBcD1, blank, blank), which indicates that UserA propagates a resource whose resource identity is 123, the propagation behavior identity is aBcD1, and there is no upper-level propagation user and no upper-level propagation behavior identity.

When user B propagates the resource address that is propagated by user A, a resource address propagated by user B is changed tohttp://bao.com/rs_123?sharer=UserB&shareNo=aBcD2, where UserB is a user identity of user B, and aBcD2 is a propagation behavior identity. The server side writes UserB and aBcD2 into a log (123, UserB, aBcD2, UserA, aBcD1).

When user C propagates the resource address that is propagated by user B, a resource address propagated by user C user is http://bao.com/rs_123?sharer=UserC&shareNo=aBcD3, where UserC is a user identity of user C, and aBcD2 is a propagation behavior identity. The server side writes UserC and aBcD3 into a log (123, UserC, aBcD3, UserB, aBcD2).

In an embodiment of the present invention, a complete propagation path of a resource address may be recorded in a log, which helps trace a propagation situation of a resource, and is implemented easily and simply.

In another embodiment of the present invention, in order not to increase a data volume of the log, the server side may backtrace the propagation path of the resource address according to the log.

In an embodiment of the present invention, the server side may generate a propagation relational tree according to the backtraced propagation path of the resource address, so as to clearly and visually present the propagation situation of the resource.

In the foregoing example, a propagation relational tree of the resource whose resource ID is 123 is: 123, {(aBcD1, UserA), (aBcD2, UserA->UserB), (aBcD3, UserA->UserB->UserC)}.

When generating the propagation relational tree according to the log (123, UserC, aBcD3, UserB, aBcD2), the server side first finds a storage location of the propagation relational tree of the resource according to the resource ID of 123, then searches for a value of an upper-level node aBcD2, finds UserA->UserB by searching, adds UserC to this value to form a node (aBcD3, UserA->UserB->UserC), and adds the node to the propagation relational tree.

In this embodiment of the present invention, there is a time sequence for forming a resource propagation relational tree. The server side processes logs that have a same resource ID according to the time sequence. This can ensure that when a log is processed, all corresponding upper-level nodes can be found.

In another embodiment of the present invention, the server side may also form no propagation relational tree, and after backtracing the propagation path of the resource address, the server side uses a key-value (key-value) to store a resource propagation relationship; where Key is obtained by splicing a resource identity and a propagation behavior identity. For example, if the resource identity is 123, and the propagation behavior identity is aSd, Key may be 123.aSd, and may also be aSd_123.
For example, in the foregoing resource propagation scenario of UserA->UserB->UserC, backtracing the propagation path may be implemented by storing the following data, helping quantize contributions made by users to resource propagation:

123. aBcD=>(UserA)

123. aBcD2=>(UserA, UserB)

123. aBcD3=>(UserA, UserB, UserC)

However, establishing the propagation relational tree 123, {(aBcD1. UserA), (aBcD2, UserA->UserB), (aBcD3, UserA->UserB->UserC)}can help visually present the propagation situation of the resource.

In a preferred embodiment of the present invention, by tracing the propagation path of the resource address, contributions made by each propagator in the propagation path to resource propagation may be quantized and evaluated by using a bonus point or in a similar manner.

In an implementation example of the present invention, calculation may be performed by using the following formula:

$$v [ Count + ( 1 - μ ) {\sum }_{lower \text{-} level} Count ] \times {μ}^{Layer}$$

where:

μ is a distribution coefficient of a propagator in a propagation chain of the resource address;

Layer is a serial number of a layer, at which the propagator is located, in the propagation chain of the resource address, starting from 0;

V is a click bonus point of the resource address; and

Count is a page view of the resource address.

A propagation path shown in FIG. 4 is used as an example. It is assumed that v=5, and μ=8, then:

if page views of a resource address propagated by user U1 are 2, and user U1 forwards content to user U2 or shares the content with user U2, bonus points of a propagation contribution made by user U1 to the content are: 5*[2+0.2*(0+10)]*0.8⁰=20;

if user U2 forwards the content to user U3 or shares the content with user U3, bonus points of a propagation contribution made by user U2 to the content are: 5*(0+0.2*10)*0.8¹=8; and

if page views of the resource address propagated by user U3 are 10, bonus points of a propagation contribution made by user U3 to the content are: 5*(10+0.2*0)*0.8²=32.

A sum of the bonus points of propagation contributions made by users U1, U2, and U3 to the content is:

20+8+32=60.

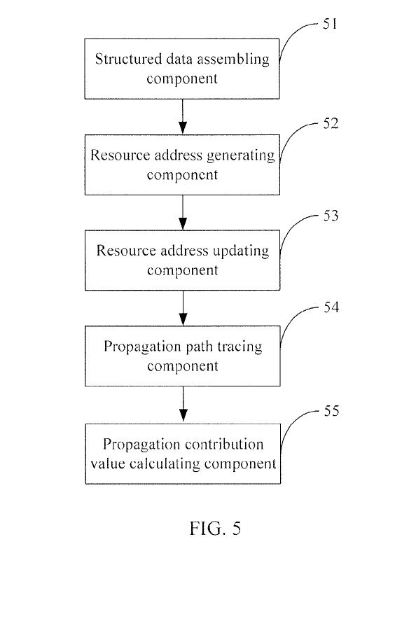

FIG. 5 shows a structure of a resource propagation system according to an embodiment of the present invention. For ease of description, only a part related to the present invention is shown.

The resource propagation system runs on a resource propagation server 160; assembles acquired content into structured data; generates a resource address for the structured data, where a propagation path parameter is configured in the resource address; in a process of propagating the resource address, updates the propagation path parameter according to propagator information; and traces a propagation path of the resource address according to an updated propagation path parameter.

A structured data assembling component 51 assembles the acquired content into the structured data.

A purpose of assembling the content into the structured data is to help flexibly add, modify, or delete other data or information after structured processing is performed on the content.

In an embodiment of the present invention, to enable content propagation to generate business value, enable a producer and a propagator of the content to obtain revenue, and facilitate content propagation, the structured data includes content value-added information.

In this embodiment of the present invention, the content value-added information may be payment prompt information of the content or advertisement content data.

A resource address generating component 52 generates the resource address for the structured data, where the resource address includes the propagation path parameter.

In this embodiment of the present invention, the resource address points to a storage location of the structured data, and a user can acquire and view the structured data by accessing the resource address. The resource address usually uses a URL or a URI.

In this embodiment of the present invention, the propagation path parameter is used to identify a propagation behavior between a propagator and a previous propagator of the resource address.

In a preferred embodiment of the present invention, the propagation path parameter includes the following information: a propagator parameter, a previous-propagator parameter, and a propagation behavior identity.

The propagator parameter is used to identify a user who performs login and propagates a current resource address, indicating who propagates the resource address. The propagator parameter is usually formed by a user identity used by the user to perform login. If a resource is original content, a propagator refers to a content producer.

The previous-propagator parameter is used to identify a previous propagator of the current resource address, indicating whom the resource address propagated by the propagator comes from. A purpose of carrying this parameter in the resource address is to enable a server side to trace a propagation path of the resource address, helping understand a propagation situation of the resource address.

The propagation behavior identity is used to identify a resource address propagation behavior between a propagator and a previous propagator. A backtracing analysis on the propagation path may be performed by using this parameter in combination with the previous-propagator parameter.

In this embodiment of the present invention, the propagation path parameter is used to identify a propagation behavior between a propagator and a previous propagator of the resource address.

In a preferred embodiment of the present invention, to help the server side quickly count a propagation depth of the resource address, the number of propagation layers is further configured in the propagation path parameter. Each time the resource address is propagated, this parameter value is increased by 1, that is, the number of propagation layers of a resource address after propagation is the number of propagation layers of the original resource address plus 1. If the resource is propagator-originated, this parameter value is 0.

In a preferred embodiment of the present invention, to protect the resource address from unauthorized alteration and assembling, a parameter signature value is further configured in the resource address.

The parameter signature value is obtained by performing computation on the propagation path parameter in the resource address by using a signature algorithm. When any parameter in the propagation path parameter changes, the parameter signature value changes; therefore, it can be determined, by detecting whether the signature value changes, whether the resource address is altered or assembled without authorization.

In the process of propagating the resource address, a resource address updating component 53 updates the propagation path parameter according to the propagator information of the resource address.

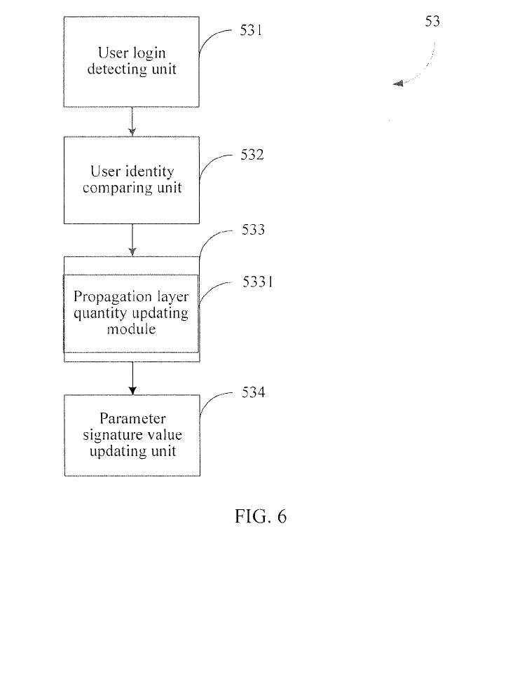

As shown in FIG. 6, when a user propagates the resource address, a user login detecting unit 531 detects whether the user is in a login state.

When the user is in the login state, a user identity comparing unit 532 determines whether a user identity used by the user to perform login is the same as the propagator parameter in the resource address.

When the user identity used by the user to perform login is different from the propagator parameter in the resource address, a propagation path parameter updating unit 533 updates the propagator parameter in the resource address with the user identity used by the user to perform login, sets the previous-propagator parameter in the resource address to the propagator parameter before updating, and calculates and updates the propagation behavior identity.

In an embodiment of the present invention, when the number of propagation layers is configured in the propagation path parameter, and each time the resource address is propagated, a propagation layer quantity updating module 5331 increases the number of propagation layers in the resource address by 1.

In another embodiment of the present invention, when a parameter signature value is configured in the resource address, a parameter signature value updating unit 534 recalculates a parameter signature value of the resource address according to the updated propagation path parameter.

A propagation path tracing component 54 traces the propagation path of the resource address according to the updated propagation path parameter.

In an embodiment of the present invention, the propagation path parameter is recorded in a form of a log.

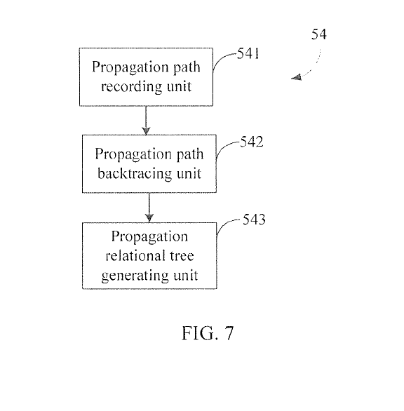

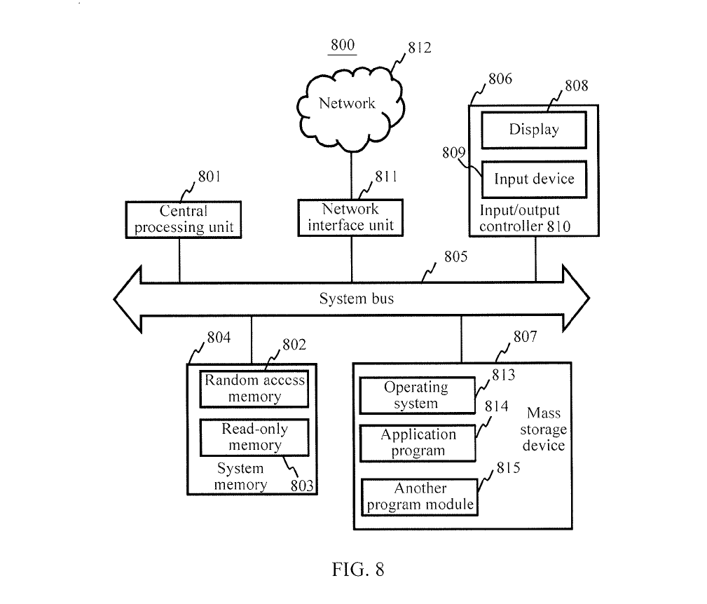

As shown in FIG. 7, a propagation path recording unit 541 records the propagation path parameter in the form of a log.

In an embodiment of the present invention, the propagation path recording unit 541 may record a complete propagation path of a resource address in a log, which helps trace a propagation situation of a resource, and is implemented easily and simply.

In another embodiment of the present invention, in order not to increase a data volume of the log, a propagation path backtracing unit 542 may backtrace the propagation path of the resource address according to the log.

In a preferred embodiment of the present invention, a propagation relational tree generating unit 543 may generate a propagation relational tree according to the backtraced propagation path of the resource address, so as to clearly and visually present the propagation situation of the resource.

In a preferred embodiment of the present invention, by tracing the propagation path of the resource address, contributions made by each propagator in the propagation path to resource propagation may be quantized and evaluated by using a bonus point or in a similar manner.

A propagation contribution value calculating component 55 calculates a propagation contribution value of the propagator according to the propagation path of the resource address.

In an implementation example of the present invention, calculation may be performed by using the following formula:

$$v [ Count + ( 1 - μ ) {\sum }_{lower \text{-} level} Count ] \times {μ}^{Layer}$$

where:

μ is a distribution coefficient of a propagator in a propagation chain of the resource address;

Layer is a serial number of a layer, at which the propagator is located, in the propagation chain of the resource address, starting from 0;

V is a click bonus point of the resource address; and

Count is a page view of the resource address.

It should be noted that the resource propagation system provided in the foregoing embodiments is described only by using division of the foregoing functional modules as an example. In an actual application, the foregoing functions may be allocated to different functional modules for implementation according to a requirement. That is, an internal structure of the resource propagation system is divided into different functional modules to implement all or a part of the functions described above. In addition, the resource propagation system provided in the foregoing embodiments pertains to the same concept as the resource propagation method embodiments. For a specific implementation process, refer to the method embodiments. Details are not described herein again.

FIG. 8 shows a schematic structural diagram of a server according to an embodiment of the present invention.

Both a content server 140 and a resource propagation server 160 may use this structure to implement the resource propagation method provided in the foregoing embodiments.

A server 800 includes a central processing unit (CPU) 801, a system memory 804 that includes a random access memory (RAM) 802 and a read-only memory (ROM) 803, and a system bus 805 that connects the system memory 804 and the central processing unit 801. The server 800 further includes a basic input/output system (I/O system) 806 that helps components in a computer to transmit information and a mass storage device 807 that is configured to store an operating system 813, an application program 814, and another program module 815.

The basic I/O system 806 includes a display 808 that is configured to display information and an input device 809 such as a mouse or a keyboard that is configured for a user to input information. Both the display 808 and the input device 809 are connected to the central processing unit 801 by using an input/output controller 810 that is connected to the system bus 805. The basic I/O system 806 may further include the input/output controller 810, so as to receive and process inputs from multiple other devices such as the keyboard, the mouse, and an electronic stylus. Similarly, the input/output controller 810 further provides an output to a display screen, a printer, or an output device of another type.

The mass storage device 807 is connected to the central processing unit 801 by using a mass storage controller (not shown in the figure) that is connected to the system bus 805.

The foregoing system memory 804 and mass storage device 807 may be collectively referred to as a memory.

The mass storage device 807 and a computer readable medium associated with the mass storage device 807 provide non-volatile storage for the server 800. That is, the mass storage device 807 may include a computer readable medium (not shown in the figure) such as a hard disk or a CD-ROM drive.

Without loss of generality, the computer readable medium may include a computer storage medium and a communications medium. The computer storage medium includes a volatile, non-volatile, movable, or unmovable medium that is implemented by using any method or technology for storing information such as a computer readable instruction, a data structure, a program module, or other data. The computer storage medium includes a RAM, a ROM, an EPROM, an EEPROM, a flash memory, another solid-state storage medium, a CD-ROM, a DVD, another optical storage medium, a cassette, a magnetic tape, a magnetic disk, or anther magnetic storage device. Certainly, a person skilled in the art may learn that the computer storage medium is not limited to the foregoing types.

According to embodiments of the present invention, the server 800 may also run on a remote computer that is connected to a network by using a network such as the Internet. That is, the server 800 may be connected to a network 812 by using a network interface unit 811 that is connected to the system bus 805, or the server 800 may also be connected to a network of another type or a remote computer system (not shown in the figure) by using the network interface unit 811.

The memory further includes one or more programs, and the one or more programs are stored in the memory and are configured to be executed by one or more central processing units 801. The foregoing one or more programs include programs used to perform the methods shown in FIG. 2 and FIG. 3.

A person of ordinary skill in the art may understand that all or a part of the steps of the embodiments may be implemented by hardware, and may also be implemented by a program instructing related hardware. The program may be stored in a computer-readable storage medium. The foregoing storage medium may be a read-only memory, a magnetic disk, or an optical disc.

According to the embodiments of the present invention, to-be-propagated content is assembled into structured data, a resource address that includes a propagation path parameter is generated for the structured data, and different propagation phases of a resource are traced by using the propagation path parameter in the resource address. Therefore, contributions made by different propagation phases to resource propagation can be evaluated and counted, so as to stimulate different phases to expand resource propagation, thereby greatly increasing value generated due to resource propagation.

The foregoing descriptions are merely exemplary embodiments of the present invention, but are not intended to limit the present invention. Any modification, equivalent replacement, or improvement made without departing from the spirit and principle of the present invention should fall within the protection scope of the present invention.

What is claimed is:

1. A resource propagation method, wherein the method comprises the following steps:
assembling acquired content into structured data;
generating a resource address for the structured data, wherein the resource address comprises a propagation path parameter;
in a process of propagating the resource address, updating the propagation path parameter according to propagator information of the resource address; and
tracing a propagation path of the resource address according to an updated propagation path parameter, wherein
the propagation path parameter is used to identify a propagation behavior between a propagator and a previous propagator of the resource address.

2. The resource propagation method according to claim 1, wherein the structured data comprises content value-added information.

3. The resource propagation method according to claim 2, wherein the content value-added information is payment prompt information of the content or advertisement content data.

4. The resource propagation method according to claim 1, wherein the propagation path parameter comprises the following information:
a propagator parameter, used to identify a user who performs login and propagates a current resource address;
a previous-propagator parameter, used to identify a previous propagator of the current resource address; and
a propagation behavior identity, used to identify a resource address propagation behavior between a propagator and a previous propagator.

5. The resource propagation method according to claim 4, wherein the propagation path parameter further comprises:
the number of propagation layers, used to indicate a propagation depth of the resource address; wherein
each time the resource address is propagated, the number of propagation layers in the resource address is increased by 1.

6. The resource propagation method according to claim 4, wherein the resource address further comprises:
a parameter signature value calculated according to the propagation path parameter.

7. The resource propagation method according to claim 4, wherein the step of updating the propagation path parameter according to propagator information of the resource address specifically comprises:
when the user propagates the resource address, detecting whether the user is in a login state;
when the user is in the login state, determining whether a user identity used by the user to perform login is the same as the propagator parameter in the resource address; and
when the user identity used by the user to perform login is different from the propagator parameter in the resource address, updating the propagator parameter in the resource address with the user identity used by the user to perform login, setting the previous-propagator parameter in the resource address to the propagator parameter before updating, and calculating and updating the propagation behavior identity.

8. The resource propagation method according to claim 1, wherein the propagation path parameter is recorded in a form of a log.

9. The resource propagation method according to claim 8, wherein the step of tracing a propagation path of the resource address according to an updated propagation path parameter comprises:
backtracing the propagation path of the resource address according to the propagation path parameter recorded in the log.

10. The resource propagation method according to claim 9, wherein the step of tracing a propagation path of the resource address according to an updated propagation path parameter further comprises:
generating a propagation relational tree according to the backtraced propagation path of the resource address.

11. The resource propagation method according to claim 1, wherein the method further comprises the following step:
calculating a propagation contribution value of the propagator according to the propagation path of the resource address.

12. The resource propagation method according to claim 11, wherein the propagation contribution value is calculated by using the following formula:
$$v [ Count + ( 1 - μ ) {\sum }_{lower \text{-} level} Count ] \times {μ}^{Layer}$$
wherein:
μ is a distribution coefficient of the propagator in a propagation chain of the resource address;
Layer is a serial number of a layer, at which the propagator is located, in the propagation chain of the resource address, starting from 0;
V is a click bonus point of the resource address; and
Count is a page view of the resource address.

13. A resource propagation system, wherein the system comprises:
a structured data assembling component, configured to assemble acquired content into structured data;
a resource address generating component, configured to generate a resource address for the structured data, wherein the resource address comprises a propagation path parameter;
a resource address updating component, configured to: in a process of propagating the resource address, update the propagation path parameter according to propagator information of the resource address; and
a propagation path tracing component, configured to trace a propagation path of the resource address according to an updated propagation path parameter; wherein
the propagation path parameter is used to identify a propagation behavior between a propagator and a previous propagator of the resource address.

14. The resource propagation system according to claim 13, wherein the structured data comprises content value-added information.

15. The resource propagation system according to claim 14, wherein the content value-added information is payment prompt information of the content or advertisement content data.

16. The resource propagation system according to claim 13, wherein the propagation path parameter comprises the following information:
a propagator parameter, used to identify a user who performs login and propagates a current resource address;
a previous-propagator parameter, used to identify a previous propagator of the current resource address; and
a propagation behavior identity, used to identify a resource address propagation behavior between a propagator and a previous propagator.

17. The resource propagation system according to claim 16, wherein the propagation path parameter further comprises:
the number of propagation layers, used to indicate a propagation depth of the resource address; wherein
each time the resource address is propagated, the number of propagation layers in the resource address is increased by 1.

18. The resource propagation method according to claim 16, wherein the resource address further comprises:
a parameter signature value calculated according to the propagation path parameter.

19. The resource propagation system according to claim 16, wherein the resource address updating component comprises:
a user login detecting unit, configured to: when a user propagates the resource address, detect whether the user is in a login state;
a user identity comparing unit, configured to: when the user is in the login state, determine whether a user identity used by the user to perform login is the same as the propagator parameter in the resource address; and
a propagation path parameter updating unit, configured to: when the user identity used by the user to perform login is different from the propagator parameter in the resource address, update the propagator parameter in the resource address with the user identity used by the user to perform login, set the previous-propagator parameter in the resource address to the propagator parameter before updating, and calculate and update the propagation behavior identity.

20. The resource propagation system according to claim 13, wherein the propagation path tracing component comprises:
a propagation path recording unit, configured to record the propagation path parameter in a form of a log.

21. The resource propagation system according to claim 20, wherein the propagation path tracing component further comprises:
a propagation path backtracing unit, configured to backtrace the propagation path of the resource address according to the propagation path parameter recorded in the log.

22. The resource propagation system according to claim 21, wherein the propagation path tracing component further comprises:
a propagation relational tree generating unit, configured to generate a propagation relational tree according to the backtraced propagation path of the resource address.

23. The resource propagation system according to claim 13, wherein the system further comprises:
a propagation contribution value calculating component, configured to calculate a propagation contribution value of the propagator according to the propagation path of the resource address.

24. The resource propagation system according to claim 23, wherein the propagation contribution value is calculated by using the following formula:
$$v [ Count + ( 1 - μ ) {\sum }_{lower \text{-} level} Count ] \times {μ}^{Layer}$$
wherein:
μ is a distribution coefficient of the propagator in a propagation chain of the resource address;
Layer is a serial number of a layer, at which the propagator is located, in the propagation chain of the resource address, starting from 0;
V is a click bonus point of the resource address; and
Count is a page view of the resource address.
